(19) United States
(12) Patent Application Publication
(10) Pub. No.: US 2026/0268174 A1
(43) Pub. Date: Sep. 10, 2026

(54) REASONING GRAPHS AND USE THEREOF

(71) Applicant: Across Al, San Francisco, CA (US)

(72) Inventors: Afshin Nikzad, San Francisco, CA (US); Niloufar Salehi, San Francisco, CA (US); Alireza Shafaei, San Francisco, CA (US)

(73) Assignee: Across Al, San Francisco, CA (US)

(21) Appl. No.: 19/562,593

(22) Filed: Mar. 10, 2026

Related U.S. Application Data
(60) Provisional application No. 63/769,347, filed on Mar. 10, 2025.

(51) Int. Cl. G06N 5/022; G06F 11/1446; G06F 21/62

(52) U.S. Cl. CPC G06N 5/022; G06F 11/1469; G06F 21/6227

(57) ABSTRACT

A method includes storing raw data content as raw-data nodes in a raw data layer of a reasoning graph, generating reasoning nodes from the raw-data nodes, and storing the reasoning nodes in reasoning layers derived from underlying layers including the raw data layer. Each reasoning node includes a reason statement linking the reasoning node to an underlying node in an underlying layer. The method further includes generating a conclusion node in an output layer based on reasoning nodes from the reasoning layers and outputting an output associated with the conclusion node.

### CROSS-REFERENCE TO RELATED APPLICATIONS

This application claims the benefit of U.S. Provisional Application No. 63/769,347 filed 10 Mar. 2025, which is incorporated in its entirety by this reference.

### TECHNICAL FIELD

This invention relates generally to the multiprocess coordination field, and more specifically to a new and useful system and method for generating and maintaining a reasoning graph in the multiprocess coordination field.

### BRIEF DESCRIPTION OF THE FIGURES

FIG. 1 is a schematic representation of a variant of the method.

FIG. 2 is an illustrative example of a variant of the relationship between a multilayered reasoning graph (MRG) and a workflow.

FIG. 3 is an illustrative example of a variant of adding a concept value to the MRG.

FIG. 4 is an illustrative example of a variant of executing the workflow.

FIG. 5 is an illustrative example of a variant of determining an MRG.

FIG. 6 is an illustrative example of executing a workflow.

FIG. 7 is an illustrative example of a variant of updating a reasoning graph and executing a workflow.

FIG. 8 is an illustrative example of a variant of the different layers of the MRG.

FIG. 9 is an illustrative example of a variant of the method including private and public nodes.

### DETAILED DESCRIPTION

The following description of the embodiments of the invention is not intended to limit the invention to these embodiments, but rather to enable any person skilled in the art to make and use this invention.

### 1. Overview

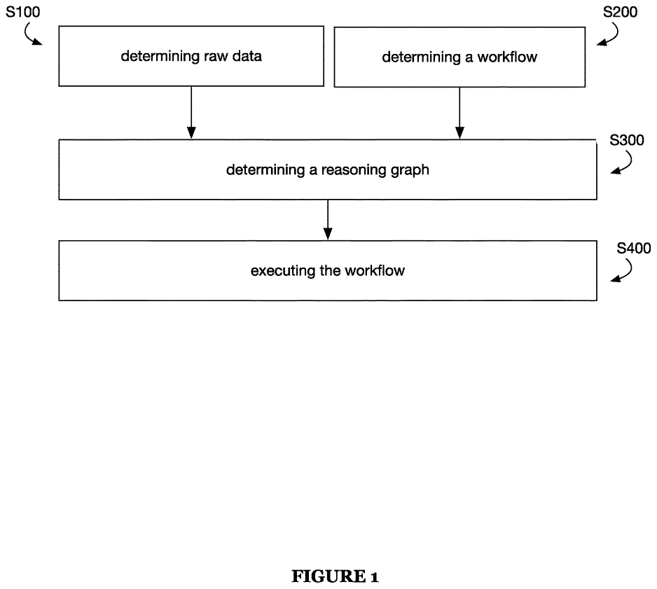

As shown in FIG. 1, the method can include: determining raw data S100; determining a workflow S200; determining a reasoning graph S300; and executing the workflow S400. The method functions to generate and maintain a multilayered reasoning graph for multi-agent collaboration.

In an illustrative example, variants of the method can include: determining a workflow including a set of tasks, where each task includes a set of concepts; seeding a reasoning graph with the set of concepts; extracting values for the concepts (e.g., from raw data); organizing the concept values within the reasoning graph (e.g., adding nodes and edges for new sub-concepts; merging sub-concepts by generating a parent concept and linking the sub-concepts with the parent concept; removing conflicting concept values; marking concept values as outdated or invalid; etc.); and optionally updating concept references within tasks (e.g., to reference a specific concept sub-node instead of the concept's parent node). The workflow can be executed by: retrieving values for concepts associated with a task, executing the task based on the retrieved concept values, optionally writing the task output back to the reasoning graph, and repeating the process for subsequent tasks until the workflow is complete.

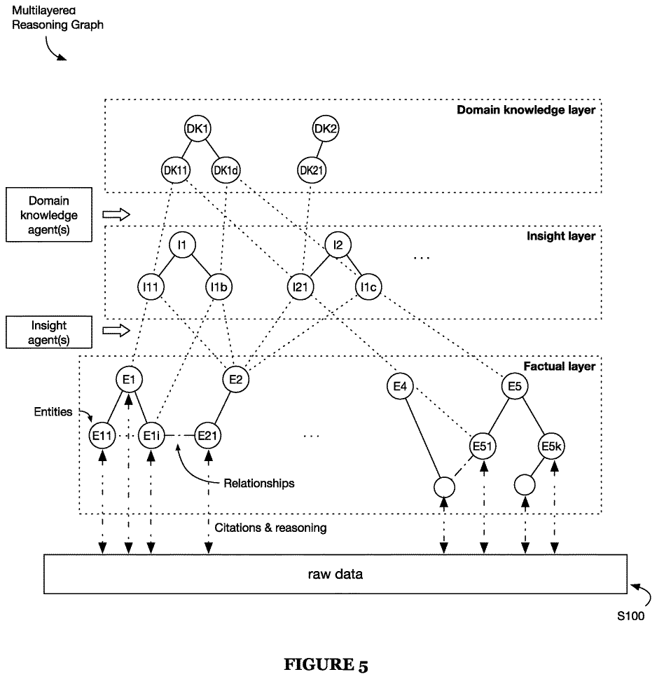

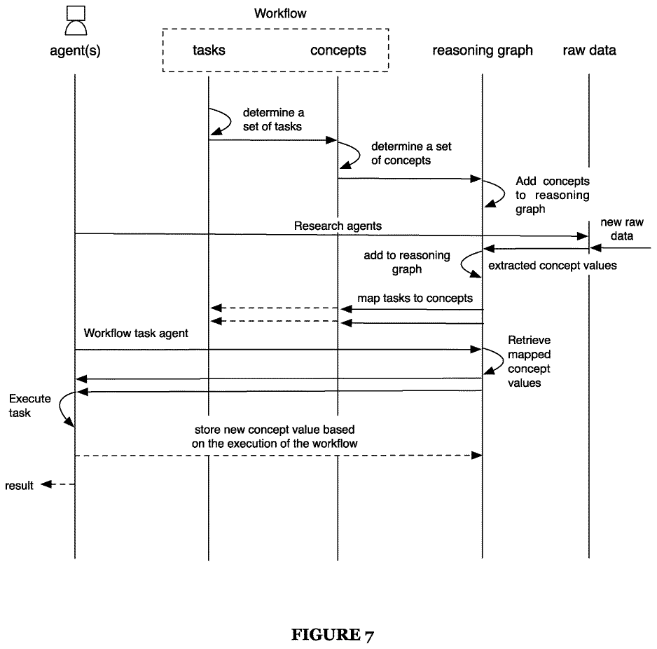

In a specific example, the reasoning graph can be a multilayered reasoning graph (MRG), including a raw data layer, a factual data layer (e.g., entity and relationship layer), an insight layer (e.g., contextual and derived insights layer), and a domain knowledge layer. In this specific example, extracting concept values can include: extracting factual values from raw data to populate a factual layer (e.g., using a research agent); extracting insights from nodes of the factual layer to populate an insight layer (e.g., using an insight agent); and/or extracting domain-specific knowledge from the insights to populate a domain knowledge layer (e.g., using a domain knowledge agent), where the workflow tasks can reference concepts from the factual layer, insight layer, domain knowledge layer, and/or other layers (e.g., using a workflow task agent). In variants, multiple domain knowledge layers for different domains can be connected to the same underlying insight, factual, and/or raw data layers. Examples are shown in FIG. 5 and FIG. 7.

In one example of a reasoning graph, a base layer includes raw data nodes and optionally metadata associated with the raw data nodes. A next layer includes factual nodes representing facts or statements extracted from the raw data nodes. A next layer includes insight nodes representing inferred needs derived from the factual nodes. A next layer includes action nodes representing recommended actions, including next-best-action recommendations. The output can include a list of next-best actions, a highest-rated next action, and/or another suitable output.

### 2. Technical Advantages

Variants of the technology can confer one or more advantages over conventional technologies.

First, variants of the technology can provide workflow-specific structure through customizable frameworks that adapt to different operational contexts. For example, the system can automatically organize and structure data, processes, and outputs according to predefined workflow requirements (e.g., clinical trials, manufacturing processes, research protocols). This structured approach can reduce organizational overhead and streamline computational efficiency compared to generic, one-size-fits-all solutions.

Second, variants of the technology can enable complex analyses and asynchronous collaboration by providing a shared memory space (e.g., a multilevel reasoning graph) that can be read from and/or written to by multiple agents. The system can support parallel processing of computational tasks (e.g., data analysis, model training, simulation runs) while maintaining data consistency.

Third, variants of the technology can enhance explainability through transparent documentation of decision processes and data lineage. The system can generate detailed audit trails and visualization of computational workflows (e.g., data transformations, model parameters, decision criteria, etc.), making it possible to understand and validate results. This can facilitate regulatory compliance and enable stakeholders to better understand the basis for system outputs.

Fourth, variants of the technology can support continuous reasoning and decision-making through real-time data processing and analysis capabilities. The system can continuously update the reasoning graph and adjust recommendations based on new information (e.g., sensor data, user feedback, external events), enabling dynamic response to changing conditions. This can lead to more informed and timely decision-making compared to static or periodic analysis approaches.

Fifth, variants of the technology can support retroactive correction and “memory replay” by maintaining historical snapshots and enabling the system to reprocess memory from a past point in time when data was missed, removed, corrected, or when an improved agent version is deployed, thereby allowing a corrected and auditable evolution of the MRG state.

Sixth, variants of the technology can implement comprehensive security and access control mechanisms to protect sensitive information and resources. The system can support fine-grained permission management (e.g., at the conceptual node level) and maintain detailed audit logs of all system access and modifications. This can help organizations maintain data privacy and regulatory compliance while enabling appropriate information sharing.

Seventh, variants of the technology can support meta-schema evolution through an architect agent. By analyzing patterns in historical deal outcomes and user feedback, the system can autonomously propose new collection types or relationship links (e.g., identifying a missing infrastructure dependency) to refine the memory structure for future workflows. This allows the system to transition from a static data repository to a self-optimizing reasoning engine.

However, further advantages can be provided by the system and method disclosed herein.

### 4. Method

As shown in FIG. 1, the method can include: determining raw data S100; determining a workflow S200; determining a reasoning graph S300; and executing the workflow S400. The method functions to generate and maintain a multilayered reasoning graph for multi-agent collaboration.

In variants, the reasoning graph can be implemented as a queryable memory graph, where the memory can be searched, filtered, and traversed using queries. The memory graph can be defined using a set of collections and optionally a set of schemas, or alternatively be schema-free. In variants using collections, each collection can correspond to a business entity type (e.g., a person, a call, a need, a product, or a product feature). In variants using schemas, a schema can define typed fields for records in a collection, a unique identifier for each record, references between records in different collections and/or other suitable structure (e.g., such that the references link records across collections to form a graph structure). In schema-free variants, records can be stored with flexible fields without enforcing a predetermined schema, while still storing identifiers and references that link related records to form the graph structure.

In variants, the collections can include primary data collections (e.g., call transcripts), external data collections integrated from read-only data sources (e.g., documents from an external database), and/or derived data collections generated from other collections to represent agent-produced abstractions (e.g., “needs” extracted from calls; “relevant feature” recommendations based on unresolved needs). In variants, the derived collections and/or derived nodes can be represented as a computation graph, where each derived collection can declare one or more upstream dependencies, thereby enabling the system to propagate updates from raw data through factual values and insights to domain knowledge and action artifacts.

The method can asynchronously coordinate between different tasks for complex workflows. The method can enable AI agents to retain, evolve, and reason over past interactions and new data. All or portions of the method can be performed when: a new workflow is defined (e.g., for a new enterprise), changes to an existing workflow (e.g., addition of an element in workflow), new data is received (in S100), and/or any other triggering condition. All or portions of the method can be performed in real-or near-real time, asynchronously, and/or at any other suitable time.

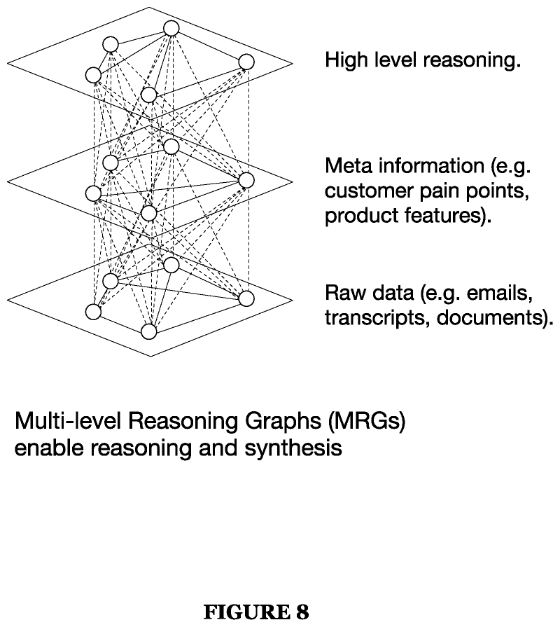

The method can be used with a multilayered reasoning graph (MRG). The MRG can serve as a structured data architecture by managing and integrating information across different levels of abstraction (e.g., example shown in FIG. 8).

In variants, the MRG can serve as a structured data architecture defined as a set of collections and schemas. Each collection can correspond to a specific business entity (e.g., ‘Person’, ‘Call’, ‘Need’, ‘Product Feature’), where schemas define typed fields and foreign keys (FKs) that link records across collections to form the quarriable reasoning graph. To ensure context separation, the MRG is partitioned using partition keys into shared partitions, accessible across all contexts, and scoped partitions, restricted to specific account or user sessions.

In variants, the MRG can include a set of concepts connected by a set of links.

The concepts can represent factual data (e.g., entities, people, product, places, dates, etc.), contextual insights (e.g., competitive advantages, risk factors, strategic priorities), domain knowledge, and/or any other data. The concepts can be represented by nodes within the reasoning graph. Each node can be associated with: a set of metadata (e.g., timestamp, etc.), raw data citation, reasoning for the value extracted from the raw data, change history (e.g., temporal evolution, what changed, reasoning for change, etc.), permissions (e.g., public, private, specific user permissions, etc.), and/or any other associations. In an example, an insight can include: “Customer is very likely to be interested in Product X.” while the associated reasoning can include: “This is based on the customer's CTO's recent talk, historical purchase patterns, and competitor announcements.”

In variants, nodes are tagged with a scope attribute including a public scope and a private scope, where a private-scope node is associated with a workflow context. In variants, execution of a workflow task that accesses a private-scope node is conditional on an access rule evaluated for a requester.

In variants, the system can enforce access control using lineage, where permissions associated with a derived record are determined at least in part by access restrictions associated with one or more upstream records used to generate the derived record, thereby preventing leakage of restricted content through derived conclusions.

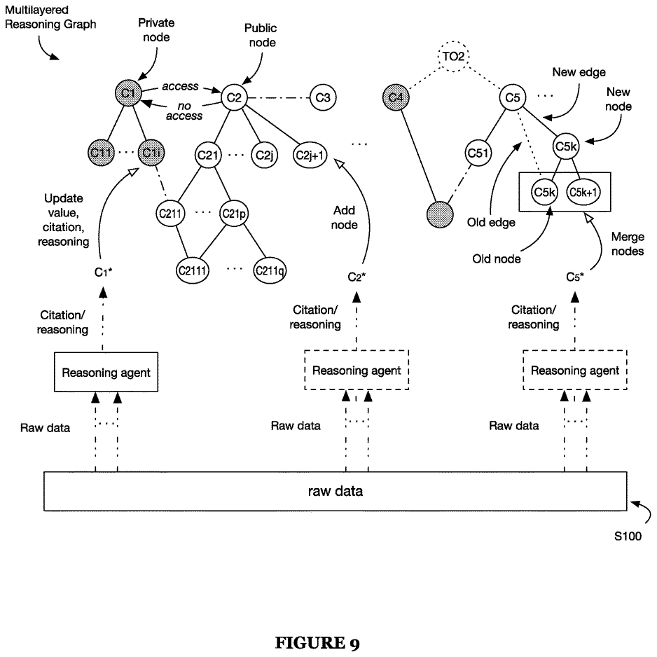

In variants, when a derived node is generated using a private-scope node, the system can prevent writing the derived node to a public scope, thereby preventing leakage of restricted content through derived conclusions. An illustrative example of permissions for private and public nodes is given in FIG. 9.

In variants, each derived node in the knowledge graph and/or reasoning graph stores a reason statement that links the derived node to one or more underlying nodes used to derive the derived node, including one or more raw data nodes in the raw data layer. The reason statement can include identifiers for the underlying nodes and a description of how the underlying nodes support the derived node.

In variants, the concepts can be hierarchically organized into conceptual subgraphs, where different hierarchical layers of a concept subgraph can be associated with different abstraction layers, different ontological levels, different taxonomy levels, conceptual levels (e.g., people>industry>occupations, etc.), and/or otherwise arranged. In an example, a high-level concept (e.g., root concept) can include “people”, an intermediate-level concept in the subgraph can include different background classes, and the leaf concepts of the subgraph can include individual people's names.

The concept nodes can be populated from the workflow (e.g., from concepts extracted from the workflow tasks), populated by a user, generated by MRG agents (e.g., when a similar concept or subconcept node does not exist), be manually populated, and/or otherwise generated. The concept values are preferably generated by the MRG agents, but can alternatively be manually generated or otherwise generated.

However, the concepts can be otherwise configured.

The links can represent connections between the concepts, such as taxonomic links, ontological links (e.g., based on hierarchical ontologies), contextual links (e.g., relevance in a given context), semantic links (e.g., meaning-based connections), affinity (e.g., strength of concept), citations (e.g., the concept value that was used to determine the current node's value), logical links (e.g., concepts that are commonly related or considered together), task links (e.g., the concepts are used in the same task), and/or any other association. The links can be represented by edges within the reasoning graph and/or otherwise represented. Each link can be associated with: a set of metadata, reasoning for the link, change history (e.g., temporal evolution, what changed, reasoning for the change, etc.), and/or any other associations. The links can be determined by agents (e.g., research agents, organizational agents, insight agents, domain knowledge agents, etc.), manually, based on a ruleset, by the workflow (e.g., by a task in the workflow), and/or otherwise determined. However, the links can be otherwise configured.

In variants, link types can include evidence links, where an evidence link connects a derived node to one or more supporting nodes (e.g., raw data nodes, factual nodes, insight nodes), and where the evidence link stores a citation reference and an explanation indicating how the supporting node contributed to the derived node.

In variants, evidence links are implemented as cross-layer edges connecting a derived node in a higher layer to one or more supporting nodes in a lower layer, including supporting raw data nodes. In variants, each cross-layer edge stores an edge reason statement describing why the supporting node supports the derived node.

In variants, link types can include dependency links, where a dependency link indicates that a downstream node or downstream collection depends on an upstream node or upstream collection, and where dependency links are used to trigger cascade updates for derived values when upstream values change.

In variants, link types can include temporal links, where a temporal link relates a current node to a prior version of the node, and where temporal links enable time-travel queries, replay operations, and explanation of how a concept evolved over time.

In variants, link types can include contradiction links, where a contradiction link connects two nodes that assert incompatible values for a concept, and where contradiction links trigger a contradiction-resolution workflow to fork hypotheses and/or to merge, deprecate, or otherwise resolve conflicting nodes.

In variants, access control can be enforced at an edge level, where a user or agent may be permitted to access a node while being restricted from accessing one or more edges incident to the node, thereby preventing disclosure of restricted relationships even when node content is visible.

In variants, edges can store edge-specific metadata including creation source (e.g., which agent generated the edge), edge confidence, edge justification, timestamps, and change history, thereby enabling auditability and debugging of relationship formation.

In an example, the reasoning graph can be split into layers, where concept values in higher layers are determined from concept values from lower layers, or otherwise split. Alternatively, the reasoning graph can include a single layer.

In variants, each reasoning layer stores nodes derived from nodes stored in an immediately lower reasoning layer, thereby forming a hierarchical set of reasoning nodes across layers.

In an example, the multilayer reasoning graph can include a raw data layer, a set of intermediate layers, a high-level concept layer, and/or any other suitable set of layers. An example is shown in FIG. 5.

The raw data layer (bottom layer) can serve as the foundation for all higher-level abstractions in the graph. The raw data layer can include: unprocessed, structured or unstructured original data collected from various sources (e.g., emails, transcripts, publicly available information, etc.), and/or other data.

The intermediate layer(s) (middle layer) can organize and refine information into more usable forms. The intermediate layer(s) can include processed data and features extracted from the raw data. In an example, the intermediate layers can act as a bridge between the raw data and the high-level concepts. In an example, the set of intermediate layers can include a factual layer and an insight layer. The factual layer can identify entities (e.g., a customer, a competitor, a product line, etc.) and map the relationships among them (e.g., a partnership, a business transaction, or a dependency). The factual layer can also create links between items in the raw data layer. The insight layer can synthesize contextual information (e.g., factual information) to capture higher-level insights (e.g., identifying a potential risk factor in a customer contract, highlighting a noteworthy competitor mention, identifying an angle for approaching a potential customer, etc.). The insight layer can enrich the raw data with metadata, such as sentiment analysis from call transcripts or summarizations of email threads.

The high-level concept layer (top layer) can guide decision-making and task execution within the platform. In an example, the high-level concept layer can allow for advanced queries and reasoning, such as understanding how a new product feature rollout affects multiple existing customers, or discerning patterns across historical deal outcomes. The high-level concepts can be derived from the workflow (e.g., from the workflow schema), and can include abstract concepts that are used in the workflow, or be otherwise determined. The high-level concept values can be determined from the values from the intermediate layers, and/or any other values. Examples of high-level concept values can include customer pain points, product features, angles, and/or any other concepts.

In variants, the MRG can include an action layer (e.g., above an insight layer and/or a domain knowledge layer), where nodes in the action layer can represent decision artifacts for workflow execution, including next-best-actions generated for a user or downstream system.

In variants, the MRG can be partitioned using one or more partition keys to prevent leakage between contexts (e.g., between different customers/tenants, projects, opportunities, or user sessions), where a shared partition is accessible across contexts, and a scoped partition is specific to a particular context.

In variants, the MRG can be exposed via one or more interfaces (e.g., API endpoints) to external agents. For example, a first set of agents may maintain and curate a product memory in a shared partition, while a second set of external marketing agents accesses an authorized subset of that memory to generate tailored campaign outputs. This enables a common source of truth to be shared across disparate enterprise functions while maintaining strict access boundaries.

In variants, the MRG can include inferred relationships in addition to explicit relationships, where inferred relationships are generated by an agent based on semantic similarity, co-occurrence, model-predicted links, and/or other relationship inference techniques, and where each inferred relationship is stored with relationship metadata including a relationship type, a relationship confidence score, and a relationship justification.

In variants, the MRG can support contradiction handling by storing competing hypotheses for a concept as separate candidate records, and resolving contradictions using a resolver policy including recency, authority of source, citation support, user override, and/or other conflict resolution rules.

A single MRG can be shared between different workflows, different entities, different domains, and/or any other elements. Alternatively, different MRGs can be used for different workflows, different entities, different domains, and/or any other elements.

In variants, the MRG can be exposed via one or more interfaces (e.g., API endpoints) to external agents, where a first set of agents maintains and curates a product memory in a shared partition while a second set of external agents (e.g., marketing agents) accesses an authorized subset of the product memory to generate workflow outputs.

In one example of a reasoning graph, a base layer includes raw data nodes and optionally metadata associated with the raw data nodes. In this one example, the next layer (e.g., factual layer, statement layer, etc.) includes factual nodes representing facts or statements extracted from the raw data nodes (with reasoning attached to the connections between the base layer and the factual node layer). In this one example, the next layer (e.g., insight layer) includes insight nodes representing inferred needs derived from the factual nodes. A next layer (e.g., action layer) includes action nodes representing recommended actions, including next-best-action recommendations. The output can include a list of next-best actions, a highest-rated next action, and/or another suitable output. However, a reasoning graph can be otherwise arranged with any suitable number of layers.

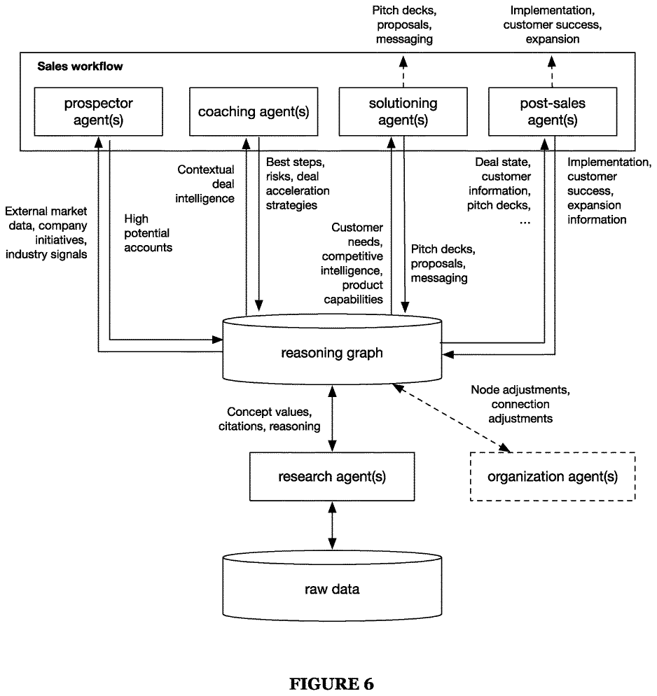

As shown in FIG. 6, the method can be performed by one or more AI agents, but can alternatively be performed by a single AI agent. Each AI agent is preferably a large model (e.g., with millions or billions of parameters), such as an LLM, generative model, transformer, DNN, and/or other model (e.g., non-deterministic model, adaptive model, probabilistic model, etc.). However, one or more of the AI agents can be a set of rules, a set of equations, a regression, a smaller neural network, and/or be otherwise configured. Each AI agent is preferably not finetuned (e.g., used off-the-shelf, with predetermined weights and biases), but can alternatively be finetuned, trained using custom data, and/or any other training configuration. In some variants, the agents can maintain the MRG over time (e.g., by merging, splitting, or re-structuring entities) and thereby improve downstream workflow outputs.

Each AI agent is preferably specific to a task (e.g., workflow task, MRG task, etc.), but can alternatively be generic. Tasks can include MRG tasks to generate and maintain the reasoning graph; workflow tasks to execute specific tasks within a workflow; and/or any other tasks. Example MRG tasks can include: extracting facts from raw data, extracting insights from facts, extracting domain knowledge from insights, and/or other MRG maintenance tasks.

Each task can be associated with a predetermined set of concepts, where the task is performed using values for the associated concept set. In an example, the AI agent for the task can be associated with concept references within the MRG for each of a predetermined set of concepts. The concept reference can be a reference (e.g., pointer, identifier, descriptor, etc.) to a concept subgraph, a parent node of concept subgraph, a specific node within concept subgraph, and/or any other reference.

Concepts can include facts, insights, domain knowledge, and/or any other concepts. The concept values are preferably predetermined by other AI agents (e.g., tasked with generating the concept values), but can alternatively be manually determined and/or otherwise determined.

Each AI agent is preferably initialized with an agent-specific context or prompt for the respective task (e.g., “your task is to extract people names from the raw data and present them in a JSON format”), but can alternatively be specifically trained or finetuned to perform the prompt.

Each AI agent can be associated with (e.g., use, be prompted with, etc.) a set of chain-of-thought prompts that provide a chain of reasoning for the AI agent to perform the AI agent's task, and/or with any other suitable set of prompts (e.g., predetermined or dynamically determined). The chain-of-thought prompts can be manually determined (e.g., by an expert), by another large model (e.g., where an LLM is prompted to generate chain-of-thought reasoning for a specific task), and/or otherwise determined. The associated prompt set can be specific to the AI agent's task, but can alternatively be a generic prompt set.

Examples of AI agents that can be used include: MRG agents, workflow task agents, and/or other agents.

The MRG agents can include: raw data agents, research agents, insight agents, domain knowledge agents, organizational agents, and/or other agents.

Raw data agents can function to generate the raw data layer. Raw data agents can aggregate raw data from a set of data sources into the raw data layer (e.g., emails, call transcripts, internal documentation, presentations, CRM updates, etc.). Raw data agents can include scrapers, data streams, bots, webhooks, headless browsers, API connections, and/or any other agents. Raw data agents can be specific to a data source, a retrieval method, and/or any other parameter.

In variants, a tool-using agent invokes an external tool (e.g., external function, service, application, large model, etc.) to obtain returned data and stores the returned data in the graph as an evidence node in a lowest layer comprising the raw data layer. In variants, a derived node in a higher layer includes a reason statement linking the derived node to the evidence node.

Research agents can function to generate the factual layer. Research agents can extract facts from raw data, provide citations for fact values, provide reasoning for why and/or how the fact's value was extracted from the cited raw data, and/or any other function. Research agents can be specific to a concept (e.g., fact) or subconcept (e.g., node within the concept subgraph), but can alternatively be generic across concepts.

In variants, the research agent can generate factual nodes representing entities and relationships and stores, in each factual node, a citation reference to at least one raw data node and an explanation indicating how the factual node was derived from the cited raw data node.

Insight agents can function to generate the insight layer. Insight agents can extract insights from facts (and/or raw data), provide fact (and/or raw data) citations for insight values, provide reasoning for why and/or how the insight's value was extracted from the cited facts, and/or any other function. Insight agents can be specific to a concept (e.g., insight) or subconcept (e.g., node within the concept subgraph), but can alternatively be generic across concepts.

In variants, the insight agent can generate insight nodes in an insight layer from factual nodes, and stores with an insight node a reason statement describing how the insight node was derived from the cited factual nodes.

Domain knowledge agents can function to generate the data knowledge layer. Domain knowledge agents can extract domain knowledge from insights (and/or facts or raw data), provide insight (and/or fact or raw data) citations for domain knowledge values, provide reasoning for why and/or how the domain knowledge's value was extracted from the cited insights, and/or any other function. Domain knowledge agents can be specific to a concept (e.g., domain knowledge) or subconcept (e.g., node within the concept subgraph), but can alternatively be generic across concepts.

The set of MRG agents can optionally include organizational agents, which can function to organize the reasoning graph. Organizational agents can add nodes and edges for new sub-concepts; merge sub-concepts by generating a parent concept and linking the sub-concepts with the parent concept; remove conflicting concept values; mark concept values as outdated or invalid; link citations and/or reasoning associated with child nodes to parent nodes; and/or otherwise maintain the MRG. Alternatively, these functionalities can be performed by the respective MRG agent.

Workflow task agents can function to execute workflow-specific tasks. Workflow task agents are preferably different from the MRG agents, but can alternatively be the insight agent, domain knowledge agent, and/or other MRG agent. In an example, a set of sales workflow agents can include a Prospector Agent that focuses on research and lead generation, continuously analyzing external market data, company initiatives, and industry signals to identify high-potential accounts; a Coaching Agent that acts as a strategic advisor for sales representatives, using contextual deal intelligence to recommend the best next steps, identify risks, and suggest deal acceleration strategies; a Solutioning Agent that synthesizes data from customer needs, competitive intelligence, and product capabilities to craft customized pitch decks, proposals, and messaging; and a Post-Sales Agent that ensures that once a deal is closed, the implementation, customer success, and expansion phases are handled smoothly. An example is shown in FIG. 6.

In variants, the set of agents can include an architect agent configured to analyze raw data, generated actions, and observed outcomes (including user feedback) to detect missing features in the MRG structure and to propose modifications to the memory schema, including proposing new collections, new intermediate insight layers, and/or new relationships to improve the accuracy of future autonomous actions. This can create a continuous feedback loop between deterministic workflow execution and adaptive memory configuration.

In an illustrative example, the architect agent can analyze patterns in lost deals, identify a recurring attribute that is not currently tracked (e.g., an infrastructure dependency), and propose adding a corresponding node type and/or collection so that future actions incorporate the missing attribute.

All or part of the method can be performed one or more times. All or part of the method can be concurrently performed, asynchronously performed, and/or otherwise performed.

Determining raw data S100 functions to aggregate data from different sources. S100 can be performed multiple times, continuously, at a predetermined frequency, periodically, and/or any other frequency. S100 can be performed by one or more raw data agents and/or any other agents. The raw data can be collected (from different sources), received (e.g., from a user), requested (e.g., via an API), retrieved, scraped (e.g., web scraping), and/or otherwise determined. The raw data can include enterprise data, new data, old data, and/or any other data. Examples of raw data that can be determined can include transcripts, emails, meeting notes, CRM entries, documents (e.g., pdfs), contracts, web scrapped content, google search results, public news, and/or any other data. The raw data can be stored in the raw data layer, a raw data database, immediately processed and discarded, and/or otherwise stored.

However, determining raw data s100 may be otherwise performed.

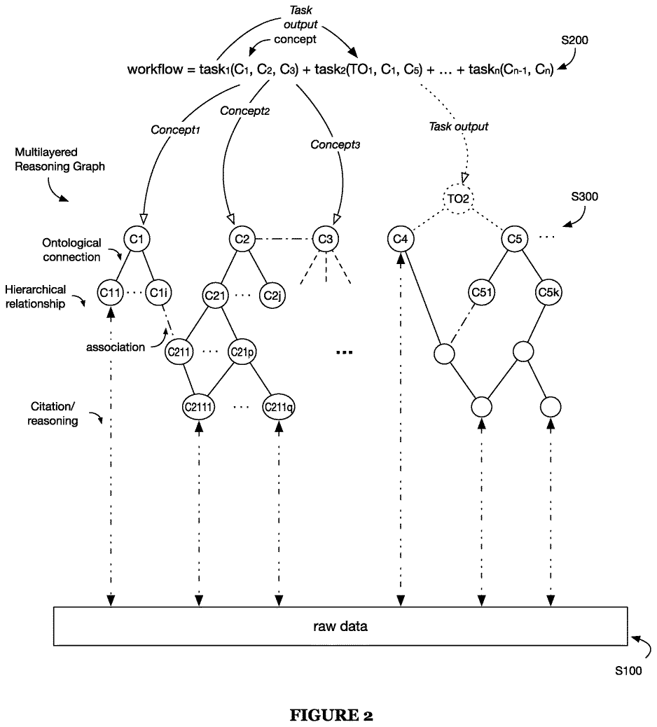

Determining a workflow S200 functions to determine a sequence of workflow tasks to achieve a specific goal or complete a project. An example is shown in FIG. 2. The workflow can be determined once, alternatively multiple times, redetermined at a predetermined frequency, and/or determined at any other frequency. A workflow is preferably deterministic. However, in some variants (e.g., to perform checks, to update an MRG, to produce “outside-the-box” thinking, etc.) the workflow can be non-deterministic.

A workflow can include one or more sets of workflow tasks. The set of workflow tasks can be ordered (e.g., into a series) or unordered. A workflow task can include one or more set of concepts (e.g., facts, insights, domain knowledge, etc.), dependency on other workflow tasks, execution logic (e.g., how to process the set of concepts into a set of workflow task outputs), concept value selection logic (e.g., which subconcept's value to select within the concept's subtree), and/or any other components. In an example, the execution logic can include an equation, a set of rules (e.g., a decision tree, etc.), a set of prompts (e.g., LLM prompts), a goal, and/or any other logic.

In variants, executing an ordered set of workflow tasks includes traversing the knowledge graph and/or reasoning graph to retrieve task inputs and to write task outputs as new nodes in one or more layers of the graph.

Determining the workflow can include defining the workflow tasks and defining relationships between the tasks.

Defining the workflow tasks can include defining the concepts used by the task (e.g., the workflow task inputs), the execution logic of the task (e.g., how the concepts are transformed), the output of the workflow task, how the workflow task output should be handled (e.g., passed to another workflow, presented to a user, written to the MRG, used to select or initialize another task, etc.), and/or defining another aspect of the workflow task. All or portions of the workflow can be received (e.g., from a user), predicted (e.g., by an LLM, etc.), extracted (e.g., from an existing SOP, documentation, industry practice, industry standard, description or video of the workflow, etc.), and/or otherwise determined. All or portions of the workflow can be manually determined or automatically determined, and/or otherwise determined.

In a first variant, S200 can include manually determining a workflow. For example, a user can explicitly state the workflow (e.g., by demonstrating the workflow, by using a codeless graphical workflow construction interface, by describing the workflow, etc.), and/or otherwise specify the workflow.

In a second variant, S200 can include determining a workflow using a model (e.g., an LLM). In an example, the agent can prompt a model (e.g., LLM) to determine a workflow for a given goal, receive a set of tasks, and optionally query the LLM to determine how to achieve the task (e.g., the concepts that need to be determined for the task, how to evaluate the concepts, etc.). In a second example, an agent can retrieve the most common workflow for a type of business or domain.

In a third variant, S200 can include determining a workflow based on the reasoning graph. In an example, the agent can explore or analyze the reasoning graph and suggest a workflow by identifying key tasks and concepts.

In variants, the workflow is received as a schema-free natural language workflow description, and the system extracts an ordered set of tasks from the schema-free natural language workflow description.

In variants, S200 can also include incorporating feedback to refine and adjust workflows over time and/or any other workflow determination methods.

However, determining a workflow s200 may be otherwise performed.

Determining a reasoning graph S300 functions to generate and maintain a reasoning graph. S300 can be performed after S200, before S400, and/or at any other time. S300 can be performed by one or more MRG agents, the workflow task agents, and/or any other agents.

In variants, determining a reasoning graph S300 includes initializing the reasoning graph and determining concept values.

In variants, determining a reasoning graph S300 can include configuring a memory structure, where configuring the memory structure can include defining collections and schemas (and relationships between them) representing business entities and derived entities, and optionally defining one or more partitions and access rules for each partition.

Configuring the memory structure can include defining schema elements comprising typed fields, primary keys, and/or references that link records across collections, thereby forming a quarriable memory graph that agents can reason over.

Configuring the memory structure can include defining: a shared partition accessible across contexts, and/or one or more scoped partitions associated with particular contexts, where records can be assigned to partitions using one or more partition keys to prevent leakage between contexts.

In variants, configuring the memory structure can include defining projection views that expose an authorized subset of the MRG, where a projection view specifies allowed collections, allowed fields, and allowed relationships, thereby enabling external agents to access a safe subset of shared memory while restricting scoped memory.

In variants, configuring the memory structure can include defining schema migration rules, where an evolved schema remains backward compatible with a prior schema by supporting at least one of: default values for new fields, alias fields for renamed fields, and transformation rules for migrated records.

In variants, configuring the memory structure can include defining record lifecycle rules per collection, including: whether records are immutable (e.g., append-only event collections), mutable (e.g., canonical entity profiles), or derived (e.g., recomputed on cascade update), and where the lifecycle rules govern update policies and retention policies for the collection.

In variants, configuring the memory structure can include staged deployment of schema changes, where a proposed schema change is evaluated on a sandbox dataset using replay and/or cascade updates before the proposed schema change is promoted for production use.

In variants, configuring the memory structure can include generating access credentials for external agents, where credentials are scoped to one or more partition keys and one or more projection views, thereby binding external access to authorized contexts and authorized data subsets.

In variants, configuring the memory structure can include configuring a schema-free memory structure, where records stored in the MRG are not required to conform to predetermined typed fields and are instead stored as semi-structured records (e.g., key-value maps, JSON objects, or document blobs) associated with record metadata.

In variants, the schema-free memory structure can be configured to store, for each record: a record type label, a record identifier, a partition key assignment, and/or one or more link descriptors that reference other records, where the link descriptors form a quarriable graph even when record content is schema-free.

In variants, configuring the schema-free memory structure can include defining validation policies that are enforced without requiring a fixed schema, where the validation policies include at least one of: required-citation policies, required-explanation policies, content-safety policies, deduplication policies, contradiction-detection policies, and/or access-control policies.

In variants, the system can support a schema-lite configuration, where a subset of records conform to typed schemas (e.g., canonical entities such as “Person” and “Account”) while another subset of records are stored schema-free (e.g., agent notes, transient hypotheses, extracted snippets), thereby enabling strict structure for stable objects while permitting flexible representation for evolving abstractions.

In variants, configuring the memory structure can include defining mapping rules that transform schema-free records into schema-conformant records, where mapping rules can be applied by an agent to promote a schema-free record to a typed record (e.g., when confidence exceeds a threshold or when a workflow requires a typed record).

In variants, configuring the memory structure can include defining indexing and retrieval policies for schema-free records, including: full-text indices, embedding indices, metadata indices, and/or link-based indices, where queries can retrieve schema-free records using a combination of semantic similarity and graph traversal.

In variants, configuring the memory structure can include defining migration rules between schema-free and schema-based representations, where the system promotes frequently used schema-free fields into a typed schema (e.g., via an architect agent) and optionally backfills existing schema-free records into the new typed fields.

Initializing the reasoning graph can be performed once, each time a new workflow is received, each time a new domain is onboarded, and/or any other time.

Initializing the reasoning graph can include extracting concepts from the workflow; seeding the reasoning graph with the workflow concepts; optionally identifying lower-level concepts associated with the workflow concept; and optionally seeding the reasoning graph with lower-level concepts. An example is shown in FIG. 2.

Extracting concepts from the workflow functions to identify the concepts required for each task. In a first variant, extracting concepts from the workflow can include extracting concepts referenced by the workflow tasks. In a second variant, extracting concepts can include extracting concepts from the domain that the workflow belongs to (e.g., from the sales domain, from a technical domain, etc.). In a third variant, extracting concepts from the workflow can include identifying the workflow task output as a concept. However, extracting concepts from the workflow may be otherwise performed.

Seeding the reasoning graph with the workflow concepts functions to create initial nodes (e.g., initial parent nodes) in the reasoning graph. The extracted concepts are preferably seeded as domain knowledge concepts (e.g., as nodes in the domain knowledge layer of the MRG), but can alternatively be seeded as insight concepts, factual concepts, as a generic concept, and/or any other concept. The layer that the concept is seeded into can be manually determined, determined based on the workflow, determined based on a predetermined tag associated with the concept, determined by a classifier, and/or any other determination method.

In a first variant, all workflow task concepts can be added as nodes to a predetermined layer (e.g., domain knowledge layer).

In a second variant, workflow task concepts can be added as nodes to layers determined based on the workflow task's dependency. In an example, concepts extracted from tasks early in the workflow (e.g., the first task) can be seeded into the factual layer, concepts extracted from intermediate tasks can be seeded into the insight layer, and concepts extracted from later tasks (e.g., the last task(s)) can be seeded into the domain knowledge layer.

However, seeding the reasoning graph with the workflow concepts may be otherwise performed.

Identifying lower-level concepts associated with the workflow concept functions to determine intermediate conceptual bridges between the workflow concept and the raw data. The lower-level concepts can be determined: manually, by querying a large model (e.g., LLM) for concepts or questions that need to be answered in order to determine the workflow concept, from a knowledge base (e.g., storing high level concept dependencies on lower-level concepts, etc.), and/or otherwise identified. Identifying lower-level concepts associated with the workflow concept can include determining insight concepts for domain knowledge concepts, determining factual concepts for insight concepts, determining factual concepts for domain knowledge concepts, then determining insight concepts summarizing the factual concepts, and/or any other concept determinations. However, identifying lower-level concepts associated with the workflow concept may be otherwise performed.

Seeding the reasoning graph with lower-level concepts functions to add additional layers to the reasoning graph. Seeding the reasoning graph with lower-level concepts can include adding nodes in the respective lower-level layers (e.g., the insight layer, the factual layer, etc.), identifying domain knowledge or workflow concepts associated with the lower-level concept and adding the lower-level concept as a child node, and/or otherwise adding the lower-level concepts to the reasoning graph. Seeding the reasoning graph with lower-level concepts can include adding edges or references connecting the lower-level concept to the workflow concept(s), and/or otherwise connecting the lower-level concepts to other concepts within the concept subgraph. However, seeding the reasoning graph with lower-level concepts may be otherwise performed.

However, initializing the reasoning graph may be otherwise performed.

Determining concept values functions to determine values for one or more concepts in the graph. The concept values are preferably determined using one or more of the MRG agents, but can additionally or alternatively be determined by one or more workflow agents, manually specified, looked up (e.g., from an oracle), and/or otherwise determined. Determining concept values can be repeated continuously, periodically, and/or otherwise performed.

In variants, determining concept values includes extracting a value for a concept and adding the concept value to the MRG. However, the concept values can be otherwise determined.

In variants, determining concept values can include triggering a cascade update operation that recomputes downstream derived collections that depend on newly ingested or modified upstream collections, where the cascade update can be initiated from an updated collection and propagates updates through dependent collections to keep derived collections up-to-date. To ensure consistency and auditability, the method can further include maintaining a set of historical snapshots of the MRG state to facilitate a retroactive replay or memory replay process. Through this process, the system can identify a missed, removed, or corrected raw data item, revert the MRG to a prior snapshot, re-ingest the relevant data, and rerun downstream updates in temporal order to produce a corrected and auditable evolution of the memory state.

In variants, upon ingestion of new raw data content, the system reverts to a historical snapshot and reprocesses downstream derivations to regenerate one or more derived reasoning nodes and, when applicable, a conclusion node in an output layer.

In variants, the cascade update operation can be incremental by recomputing only derived records whose dependency manifests reference the updated upstream record, and can mark other derived records as unchanged, thereby reducing compute cost and limiting unnecessary overwrites.

In variants, the cascade update operation can include scheduling recomputation jobs in an order consistent with the dependency graph, and can include retry policies, dead-letter handling, and partial-progress checkpoints to prevent corruption of MRG state in the presence of compute failures.

In variants, memory replay can include selective replay, where only the subgraph affected by a corrected upstream record is reverted and recomputed, rather than reverting and recomputing the entire MRG.

In variants, memory replay can include upgrade replay, where a historical dataset is reprocessed using an updated agent configuration, an updated prompt set, and/or an updated schema to regenerate derived collections while preserving provenance links to the prior derived values and storing an explanation of differences.

In variants, memory hygiene operations (e.g., deduplication, summarization, pruning of stale derived records, deprecation of superseded values, etc.) can be performed on the MRG (e.g., to improve queryability, reduce accumulation of redundant or outdated entries, etc.).

Extracting a value for a concept functions to determine a value associated with a concept.

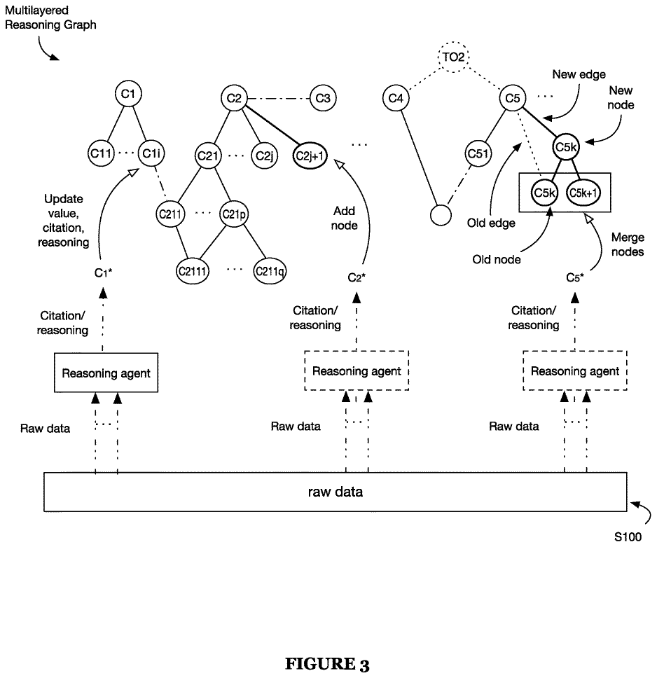

In a first variant, extracting a value for a concept can include extracting a factual data value from a set of raw data (e.g., computing the factual data value, summarizing the factual data value, etc.). Examples are shown in FIG. 3 and FIG. 5. The extraction can be performed using the research agent or other agent. This variant can additionally or alternatively include extracting the reasoning for how the factual data value was derived from the raw data.

In a second variant, extracting a value for a concept can include extracting an insight data value from a set of factual data using the insight agent based on a predetermined set of factual concepts. In a first variant, the insight agent can traverse a fact subgraph specific to a factual concept preassociated with the insight, select a fact value from the fact subgraph, and determine the insight based on the fact value. In a second variant, the insight agent can retrieve a fact value from a predetermined node in the fact subgraph. However, the insight data value can be otherwise determined. This variant can additionally or alternatively include extracting the reasoning for how the insight data value was derived from the factual data.

In a third variant, extracting a value for a concept can include extracting a domain knowledge data value from a set of insight data using the domain knowledge agent based on a predetermined set of insight concepts. In a first variant, the domain knowledge agent can traverse a fact subgraph specific to an insight concept preassociated with the domain knowledge, select an insight value from the insight subgraph, and determine the domain knowledge based on the insight value. In a second variant, the domain knowledge agent can retrieve an insight value from a predetermined node in the insight subgraph. However, the domain knowledge data value can be otherwise determined. This variant can additionally or alternatively include extracting the reasoning for how the domain knowledge data value was derived from the insight data.

However, extracting a value for a concept may be otherwise performed.

Adding the concept value to the MRG functions to update the MRG. In variants, adding the concept value to the MRG includes identifying a concept subgraph associated with the concept value; adding the concept value to the concept subgraph; and optionally updating concept references in the workflow task agents. However, concept values can be otherwise added to the MRG.

Identifying a concept subgraph associated with the concept value functions to identify which concept subgraph(s) the new value should be added to. In a first variant, concept subgraph can be for the concept associated with the respective agent that extracted the concept value (e.g., the concept for the research agent, the insight for the insight agent, the domain knowledge for the domain knowledge agent, etc.), and/or any other concept. In a second variant, identifying a concept subgraph associated with the concept value can be performed by traversing the MRG and identifying a similar concept (e.g., using cosine similarity, etc.). However, identifying a concept subgraph associated with the concept value may be otherwise performed.

The concept value can be added to the identified concept subgraph by: adding a new node to the concept subgraph, overwriting an existing node's value, deprecating invalid nodes, merging nodes, splitting nodes, pruning nodes, and/or any other node operations. Examples are shown in FIG. 3. Adding the concept value to the concept subgraph can also include modifying connections between nodes (e.g., inter-concept subgraph connections, intra-concept subgraph connections, etc.). Adding the concept value to the concept subgraph can be performed by the organizational agent, by the respective MRG agent, and/or by any other agent. Adding the concept value to the concept subgraph can also include storing citations (e.g., to lower-level concepts or data used to determine the concept value), reasoning, and/or any other auxiliary data with the node. The new concept value can be added to the concept subgraph, and/or otherwise incorporated, integrated, inserted, linked, connected, associated, merged, appended, attached, or combined with the concept subgraph.

In a first variant, adding the concept value to the concept subgraph can include adding a new node to the subgraph when the concept value represents a new concept. In an illustrative example, a new node can be added when the concept value is a new person or product line. In embodiments, this can also include identifying the conceptual hierarchical level associated with the concept value (e.g., based on a similarity with other concepts already in the MRG, etc.), adding a node at the identified level, and adding connections to a parent concept node.

In a second variant, adding the concept value to the concept subgraph can include resolving conflicts between the new concept value and old concept values. Resolving conflicts can include deduplicating concept values (e.g., when the concept values are substantially similar, within a threshold similarity score, etc.), resolving conflicts (e.g., based on recency, number of citations, and/or other rules), and/or any other conflict resolution methods.

In a third variant, adding the concept value to the concept subgraph can include merging nodes that are similar but not the same (e.g., example shown in FIG. 3). This can include creating a higher-level concept that encompasses the similar nodes, connecting the similar nodes to the new parent node, inheriting citations and reasoning from the similar nodes to the parent node, and/or any other merging actions. In an example, merging nodes can include generating an intermediate ontological node that summarizes similar subconcept nodes, and connecting the intermediate ontological node to the parent nodes and the subconcept nodes. In an illustrative example, the “people” subtree can include “janitor”, “doctor”, and “gig worker”, where the method can identify that “janitor”, “doctor”, and “gig worker” are all occupations, generate an intermediate “occupation” node, connect “janitor”, “doctor”, and “gig worker” to the new “occupation” node as children nodes, and connect the new “occupation” node as a child to the “people” node.

However, adding the concept value to the concept subgraph may be otherwise performed.

In variants, adding concept values and maintaining the MRG can include maintaining a set of historical snapshots of MRG state and enabling a retroactive replay process, where the system can: identify a missed, removed, or corrected raw data item; revert to a prior snapshot; re-ingest the raw data item; and rerun downstream updates in temporal order to produce a corrected MRG state with explanations of changes.

In variants, the system can support snapshot-consistent workflow execution, where a workflow task reads concept values from a specified MRG snapshot, and where outputs of the workflow task are written as a new MRG snapshot or as a staged draft state that is later promoted to a new MRG snapshot.

The method can optionally include updating concept references in the workflow task agents, which functions to specify which subconcept value to use for the task.

The concept references can include the subconcept node ID, a pointer to the subconcept node, and/or any other concept references.

The concept references in the workflow task agents can be updated or not be updated. The concept references in the workflow task agents can be updated based on a set of rules (e.g., update the workflow task agent to reference the most recent concept value), by predicting which subconcept will be the most relevant to the task, and/or any other updating method.

In variants where the concept references are not updated, the workflow task agents can reference a concept subtree for each concept, and traverse the respective concept subtree to identify the subconcept values to use based on a set of concept value selection logic, and/or otherwise identify which subconcept values to use.

However, optionally updating concept references in the workflow task agents may be otherwise performed.

However, adding the concept value to the MRG may be otherwise performed.

However, determining concept values may be otherwise performed.

However, determining a reasoning graph S300 may be otherwise performed.

Executing the workflow S400 functions to perform the set of workflow tasks. S400 can be performed after S300 and/or at any other time. S400 can be repeated once, at a predetermined frequency, and/or every time new data is received after S100. All or parts of the workflow can be performed sequentially, in parallel, asynchronously, and/or any other execution method. S400 can be performed by one or more of the workflow task agents, and/or by any other suitable agent. The output of executing the workflow S400 can be an action (e.g., a drafted email, etc.), a set of steps to perform an action (e.g., “recommend you contact the client regarding new product by 1) looking up the clients phone number and 2) validating based on client data”, etc.), an insight (e.g., this new product can be useful given the customer's pain point), input for another task, and/or any other output.

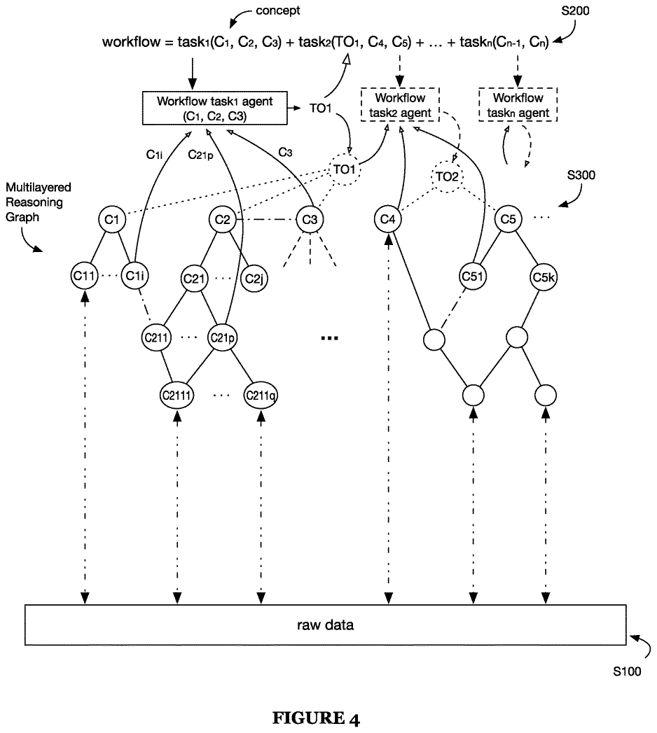

In variants, executing the workflow S400 includes retrieving concept values from the MRG; generating a workflow task output by executing the execution logic, using the retrieved concept values; optionally presenting the workflow task output to the user; and optionally writing the workflow task output to the MRG (e.g., as an insight, a domain knowledge datum, etc.). Examples are shown in FIG. 4 and FIG. 7.

Retrieving concept values from the MRG functions to identify inputs to the workflow task. In a first variant, retrieving concept values from the MRG can include retrieving the value from the concept node referenced in the workflow task agent (e.g., the value from a specific node ID). In a second variant, retrieving concept values from the MRG can include traversing the concept subgraph associated with the concept identified in the workflow task agent and selecting a value (e.g., traversing the “people” subgraph and identifying “Jerry”). The value can be selected according to a concept value selection logic (e.g., specified by the task, specified by another task, specified by the user, etc.), randomly selected, and/or otherwise selected. In an illustrative example, “Jerry” can be selected when the task agent is looking for middle-class, single individuals that have not received a paper mailer. However, retrieving concept values from the MRG may be otherwise performed.

In variants, retrieving concept values can include selecting a workflow snapshot identifier, and retrieving concept values that are consistent with the selected snapshot identifier, thereby ensuring that a workflow task reads a consistent state even when background agents are updating the MRG asynchronously.

In variants, retrieving concept values can include executing a filtered query over one or more collections to select a subset of records satisfying criteria (e.g., unresolved needs, high-confidence competitor mentions, unverified facts), and supplying the filtered subset as task inputs.

Generating a workflow task output by executing the execution logic using the retrieved concept values can include: prompting an AI agent to generate an output given the concept values; computing the output given the concept values; and/or otherwise generating the output.

In variants, generating a workflow task output can include generating an evidence pack associated with the output, where the evidence pack includes: the selected concept values, citations to supporting records, explanations of derivation, confidence values, and the snapshot identifier, thereby enabling “why this output” inspection and auditability.

In variants, the system selects a justification subgraph for a conclusion node by traversing cross-layer edges that store reasons from the conclusion node toward the raw data layer to collect supporting nodes and edges. The selected justification subgraph can be provided with the output to enable inspection of why the conclusion node was generated.

Presenting the workflow task output can include: displaying the output on a user display, populating a to-do list, generating audio or video instructions for the user; and/or otherwise presenting the workflow task output to the user.

Writing the workflow task output to the MRG can include: identifying the MRG level associated with the output (e.g., associated with the workflow task, classifying the output with an MRG level, etc.); and writing the workflow task output as a concept value to the MRG (e.g., using S300).

In variants, writing the workflow task output to the MRG can include storing a workflow execution trace record in an action layer, where the trace record stores: task identifier, input record identifiers, output artifact identifiers, and provenance pointers to the MRG snapshot used for execution.

In variants, workflow tasks can be idempotent, where rerunning a workflow task with the same snapshot identifier and execution configuration yields the same output artifact, and where the system stores a task output hash to detect redundant reruns and enable caching.

In variants, workflow execution can branch based on MRG meta-signals including: contradiction status, confidence values, freshness metadata, and access-visibility, where the workflow triggers additional verification, user approval, or data acquisition when uncertainty exceeds a threshold.

However, executing the workflow S400 may be otherwise performed.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, where one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

### Numbered List of Specific Examples

A numbered list of specific examples of the technology described herein are provided below. A person of skill in the art will recognize that the scope of the technology is not limited to and/or by these specific examples.
Specific example 1. A method comprising: storing raw data content as a set of raw-data nodes in a raw data layer of a reasoning graph; generating, from the set of raw-data nodes, a set of reasoning nodes; storing the set of reasoning nodes in a set of reasoning layers of the reasoning graph, each reasoning layer derived from a set of underlying layers comprising the raw data layer, and wherein each reasoning node of the set of reasoning nodes comprises a reason statement linking the reasoning node to an underlying node in an underlying layer of the set of underlying layers; generating a conclusion node in an output layer of the reasoning graph based on reasoning nodes from the set of reasoning layers; and outputting an output associated with the conclusion node.
Specific example 2. The method of Specific example 1, wherein generating the set of reasoning nodes comprises extracting a set of factual nodes representing facts and links between facts from the set of raw-data nodes and storing the set of factual nodes in a first reasoning layer.
Specific example 3. The method of Specific example 2, wherein each factual node stores a citation reference to a raw-data node and stores an explanation indicating how a factual node was derived from the cited raw-data node.
Specific example 4. The method of any of Specific examples 2 or 3, wherein generating the set of reasoning nodes comprises deriving insight nodes in an insight layer from the factual nodes in a lower reasoning layer.
Specific example 5. The method of any of Specific examples 1-4, wherein the reasoning statement describes how a reasoning node is derived from one or more underlying nodes.
Specific example 6. The method of any of Specific examples 1-5, wherein generating the conclusion node comprises traversing the reasoning graph according to an ordered set of tasks defined by a workflow.
Specific example 7. The method of Specific example 6, wherein the workflow is a schema-free natural language workflow description.
Specific example 8. The method of any of Specific examples 1-7, wherein generating the set of reasoning nodes is performed by a set of artificial intelligence (AI) agents, wherein an AI agent of the set of AI agents invokes an external tool to generate a tool output, and stores the tool output as an evidence node in the set of underlying layers.
Specific example 9. The method of any of Specific examples 1-8, wherein generating the output comprises selecting a justification subgraph by traversing cross-layer edges that store reasons from the conclusion node toward the raw data layer, wherein the justification subgraph comprises a subset of nodes and edges from the set of reasoning layers that support the conclusion node.
Specific example 10. The method of any of Specific examples 1-9, further comprising storing a set of historical snapshots of a portion of the reasoning graph and, in response to detecting new raw-data content, reverting to a historical snapshot in the set of historical snapshots to regenerate a reasoning node in the set of reasoning nodes.
Specific example 11. The method of any of Specific examples 1-10, further comprising storing, in the reasoning graph, a set of public-scope nodes and a set of private-scope nodes, wherein each private-scope node is associated with a workflow context, and wherein executing a routine that accesses a private-scope node is conditional on an access rule.
Specific example 12. The method of Specific example 11, further comprising preventing the routine from writing a derived node to a public scope when the derived node is derived from the private-scope node.
Specific example 13. A system comprising: a processor; a non-transitory computer readable medium, storing instructions that, when executed by the processor, cause the processor to: traverse a reasoning graph according to a workflow to determine an output, wherein the reasoning graph comprises: a set of raw data content stored as raw-data nodes in a raw data layer of the reasoning graph; and a hierarchical set of reasoning nodes stored in a set of reasoning layers of the reasoning graph, each reasoning layer configured to store reasoning nodes derived from reasoning nodes stored in an immediately lower layer, and wherein each reasoning node comprises a reason statement; and a conclusion node in an output layer of the reasoning graph based on reasoning nodes selected from the set of reasoning layers.
   Specific example 14. The system of Specific example 13, wherein the hierarchical set of reasoning nodes comprise factual nodes representing entities and relationships from the set of raw-data nodes and storing the factual nodes in a first reasoning layer.
Specific example 15. The system of any of Specific examples 13-14, wherein the reason statement comprises describing a derivation of an insight value from cited nodes.
Specific example 16. The system of any of Specific examples 13-15, wherein the workflow is a deterministic set of tasks for traversing the reasoning graph.
Specific example 17. The system of Specific example 16, wherein determining the workflow comprises receiving a schema-free natural language workflow description.
Specific example 18. The system of any of Specific examples 13-17, wherein the conclusion node is generated by selecting a justification subgraph by traversing cross-layer edges that store reasons from the conclusion node toward the raw data layer, wherein the justification subgraph comprises a subset of nodes and edges from the set of reasoning layers that support the conclusion node.
Specific example 19. The system of any of Specific examples 13-18, wherein the a non-transitory computer readable medium, storing instructions that, when executed by the processor, further cause the processor to store a set of historical snapshots of a portion of the reasoning graph and, in response to detecting new raw-data content, revert to a historical snapshot in the set of historical snapshots to regenerate a reasoning node in the set of reasoning nodes or the conclusion node.
Specific example 20. The system of any of Specific examples 13-19, wherein the a non-transitory computer readable medium, storing instructions that, when executed by the processor, further cause the processor to, in the reasoning graph, store a set of public-scope nodes and a set of private-scope nodes, wherein each private-scope node is associated with a workflow context, and wherein executing a workflow task that accesses a private-scope node is conditional on an access rule associated with a requester, wherein the method further comprises preventing the workflow task from writing a derived node to a public scope when the derived node is derived from the private-scope node.

We claim:

1. A method comprising:
storing raw data content as a set of raw-data nodes in a raw data layer of a reasoning graph;
generating, from the set of raw-data nodes, a set of reasoning nodes;
storing the set of reasoning nodes in a set of reasoning layers of the reasoning graph, each reasoning layer derived from a set of underlying layers comprising the raw data layer, and wherein each reasoning node of the set of reasoning nodes comprises a reason statement linking the reasoning node to an underlying node in an underlying layer of the set of underlying layers;
generating a conclusion node in an output layer of the reasoning graph based on reasoning nodes from the set of reasoning layers; and
outputting an output associated with the conclusion node.

2. The method of claim 1, wherein generating the set of reasoning nodes comprises extracting a set of factual nodes representing facts and links between facts from the set of raw-data nodes and storing the set of factual nodes in a first reasoning layer.

3. The method of claim 2, wherein each factual node stores a citation reference to a raw-data node and stores an explanation indicating how a factual node was derived from the cited raw-data node.

4. The method of claim 2, wherein generating the set of reasoning nodes comprises deriving insight nodes in an insight layer from the factual nodes in a lower reasoning layer.

5. The method of claim 1, wherein the reasoning statement describes how a reasoning node is derived from one or more underlying nodes.

6. The method of claim 1, wherein generating the conclusion node comprises traversing the reasoning graph according to an ordered set of tasks defined by a workflow.

7. The method of claim 6, wherein the workflow is a schema-free natural language workflow description.

8. The method of claim 1, wherein generating the set of reasoning nodes is performed by a set of artificial intelligence (AI) agents, wherein an AI agent of the set of AI agents invokes an external tool to generate a tool output, and stores the tool output as an evidence node in the set of underlying layers.

9. The method of claim 1, wherein generating the output comprises selecting a justification subgraph by traversing cross-layer edges that store reasons from the conclusion node toward the raw data layer, wherein the justification subgraph comprises a subset of nodes and edges from the set of reasoning layers that support the conclusion node.

10. The method of claim 1, further comprising storing a set of historical snapshots of a portion of the reasoning graph and, in response to detecting new raw-data content, reverting to a historical snapshot in the set of historical snapshots to regenerate a reasoning node in the set of reasoning nodes.

11. The method of claim 1, further comprising storing, in the reasoning graph, a set of public-scope nodes and a set of private-scope nodes, wherein each private-scope node is associated with a workflow context, and wherein executing a routine that accesses a private-scope node is conditional on an access rule.

12. The method of claim 11, further comprising preventing the routine from writing a derived node to a public scope when the derived node is derived from the private-scope node.

13. A system comprising:
a processor;
a non-transitory computer readable medium, storing instructions that, when executed by the processor, cause the processor to:
traverse a reasoning graph according to a workflow to determine an output, wherein the reasoning graph comprises:
a set of raw data content stored as raw-data nodes in a raw data layer of the reasoning graph; and
a hierarchical set of reasoning nodes stored in a set of reasoning layers of the reasoning graph, each reasoning layer configured to store reasoning nodes derived from reasoning nodes stored in an immediately lower layer, and wherein each reasoning node comprises a reason statement; and
a conclusion node in an output layer of the reasoning graph based on reasoning nodes selected from the set of reasoning layers.

14. The system of claim 13, wherein the hierarchical set of reasoning nodes comprise factual nodes representing entities and relationships from the set of raw-data nodes and storing the factual nodes in a first reasoning layer.

15. The system of claim 13, wherein the reason statement comprises describing a derivation of an insight value from cited nodes.

16. The system of claim 13, wherein the workflow is a deterministic set of tasks for traversing the reasoning graph.

17. The system of claim 16, wherein determining the workflow comprises receiving a schema-free natural language workflow description.

18. The system of claim 13, wherein the conclusion node is generated by selecting a justification subgraph by traversing cross-layer edges that store reasons from the conclusion node toward the raw data layer, wherein the justification subgraph comprises a subset of nodes and edges from the set of reasoning layers that support the conclusion node.

19. The system of claim 13, wherein the a non-transitory computer readable medium, storing instructions that, when executed by the processor, further cause the processor to store a set of historical snapshots of a portion of the reasoning graph and, in response to detecting new raw-data content, revert to a historical snapshot in the set of historical snapshots to regenerate a reasoning node in the set of reasoning nodes or the conclusion node.

20. The system of claim 13, wherein the a non-transitory computer readable medium, storing instructions that, when executed by the processor, further cause the processor to, in the reasoning graph, store a set of public-scope nodes and a set of private-scope nodes, wherein each private-scope node is associated with a workflow context, and wherein executing a workflow task that accesses a private-scope node is conditional on an access rule associated with a requester, wherein the method further comprises preventing the workflow task from writing a derived node to a public scope when the derived node is derived from the private-scope node.
